(19) United States
(12) Patent Application Publication
(10) Pub. No.: US 2005/0155045 A1
(43) Pub. Date: Jul. 14, 2005

(54) Disc cleaner

(75) Inventor: Yasumasa Iwamura, Kawasaki (JP)

Correspondence Address: Patrick G. Burns, Esq.;GREEN, BURNS & CRAIN, LTD., Suite 2500, 300 South Wacker Dr., Chicago, IL, 60606, US

(73) Assignee: FUJITSU LIMITED

(21) Appl. No.: 11/076,355

(22) Filed: Mar. 9, 2005

Related U.S. Application Data
(63) Continuation of application No. PCT/JP02/13202, filed on Dec. 17, 2002.

(51) Int. Cl. G11B 3/58; G11B 33/02

(52) U.S. Cl. 720/600; 369/72

(57) ABSTRACT

A disc cleaner includes a disc rotation mechanism that rotates a disc (A), a cleaning member (14) for cleaning a reading surface during the rotation of the disc (A) and a press member that brings the cleaning member (14) into contact with a press member (16). The disc cleaner is provided with a movement mechanism that moves the press member (16) along the radical direction of the disc (A) during cleaning when the disc (A) rotates, and that allows the press member (16) to reach the outside of the recording region of the disc (A) when cleaning is completed.

### TECHNICAL FIELD

The present invention relates to a disc cleaner for cleaning a media disc, such as CD, DVD, MD or MO disc.

### BACKGROUND ART

A conventional disc cleaner is constructed to perform cleaning by pressing a cleaning cloth against the reading surface of a disc using a press member (extrusion projection) and by wiping dust off the reading surface by the cleaning cloth accompanied with the rotation of the disc, for example, as disclosed in Japanese Patent Publication Hei 8-14972 and Japanese Patent Application Laid-Open Hei 3-49086. The press member is secured so as not to move along the radical direction of the disc.

However, as in the conventional technology, while cleaning is performed due to the rotation of a disc, if the press member would not move along the radical direction of a disc, much dust is accumulated in a contact zone between the cleaning cloth, situated at its usual position, and the reading surface, and the cleaning cloth easily misses the dust. In other words, with a conventional disc cleaner, when the rotation of the disc is stopped upon the completion of the cleaning and the press member is detached from the reading surface, there is the problem that a linear wiped trace of dust remains along the radical direction of the disc, which may also remain on the recording region of the disc.

### DISCLOSURE OF THE INVENTION

The objective of the present invention is to provide a disc cleaner that can clean a disc without leaving a wiped trace of dust on the recording region of a disc.

According to the present invention, a disc cleaner characterized by the fact that it has a disc rotation mechanism that rotates a disc, a cleaning member for cleaning the reading surface during the rotation of the disc, and a press member that brings the cleaning member into contact with the reading surface, and, the disc cleaner is equipped with a movement mechanism that moves the press member along the radical direction of the disc during cleaning due to the rotation of the disc, allowing the press member to reach the outside of the recording region of the disc.

A preferred Embodiment can be constructed such that the movement mechanism moves the press member from the internal circumference side to the external circumference side of the disc.

Another preferred Embodiment can be constructed such that the movement mechanism allows the press member to reach the outermost side of the external circumference of the disc upon the completion of cleaning.

Another preferred Embodiment can be constructed such that the disc is housed within a disc cartridge provided with a shutter and opening, and the disc cleaner additionally has a plate-state member from the gap between the outside edge of the opening, which appears a state where the shutter is open, and the disc, through the outside of the disc cartridge, and, the movement mechanism allows the press member to reach the upper portion of the plate-state member.

Another preferred Embodiment can be constructed such that the cleaning member is a cleaning cloth, established to pass between the press member and the reading surface, and the disc cleaner additionally has a winding mechanism for winding the cleaning member during cleaning.

Another preferred Embodiment can be constructed such that the winding direction of the cleaning member intersects with the movement direction of the press member.

Another preferred Embodiment can be constructed such that the winding direction of the cleaning member is opposite to the movement direction of the press member.

Another preferred Embodiment can be constructed such that the press member is formed from an elastic body.

Another preferred Embodiment can be constructed such that the press member has a pointed extremity for extruding the cleaning member toward the reading surface side.

Another preferred Embodiment can be constructed such that, for a set comprising the cleaning member and press member, two sets are established to enable simultaneously cleaning both sides of the disc.

Other characteristics and advantages of the present invention shall become clear according to the below mentioned description of the Embodiment with reference to drawings.

### BRIEF DESCRIPTION OF THE DRAWINGS

FIG. 1 is a top view that shows a main section of a first Embodiment.

FIG. 2 is a perspective view that shows a part of the first Embodiment.

FIG. 3 is a side view that shows a part of the first Embodiment.

FIG. 4 is a perspective view that shows a part of the first Embodiment.

FIG. 5 is a top view that shows a main section of a second Embodiment.

FIG. 6 is a perspective view that shows a main section of a third Embodiment.

FIG. 7 is an explanatory diagram for the purpose of explaining the operation according to the third Embodiment.

FIG. 8 is an explanatory diagram for the purpose of explaining the operation according to the third Embodiment.

FIG. 9 is an explanatory diagram for the purpose of explaining the operation according to the third Embodiment.

FIG. 10 is an explanatory diagram for the purpose of explaining the operation according to the third Embodiment.

FIG. 11 is an explanatory diagram for the purpose of explaining the operation according to the third Embodiment.

FIG. 12 is a top view that shows a fourth Embodiment.

FIG. 13 is a side view that shows the fourth Embodiment.

FIG. 14 is a side view that shows a main section of the fourth Embodiment.

FIG. 15 is a perspective view that shows a fifth Embodiment.

FIG. 16 is a cross sectional view that shows the fifth Embodiment.

FIG. 17 is a perspective view that shows a modified example of a press member.

FIG. 18 is an explanatory diagram for the purpose of explaining a modified example of the first and second Embodiments.

FIG. 19 is an explanatory diagram for the purpose of explaining a modified example of the third Embodiment.

### BEST MODE FOR CARRYING OUT THE INVENTION

Preferred Embodiments of the present invention are explained hereafter, with reference to the drawings.

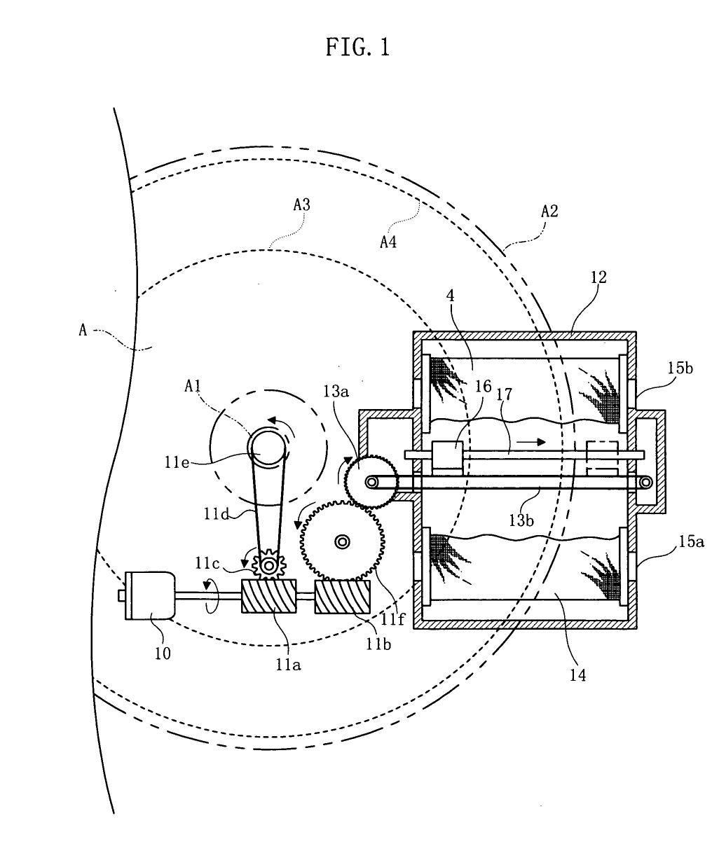

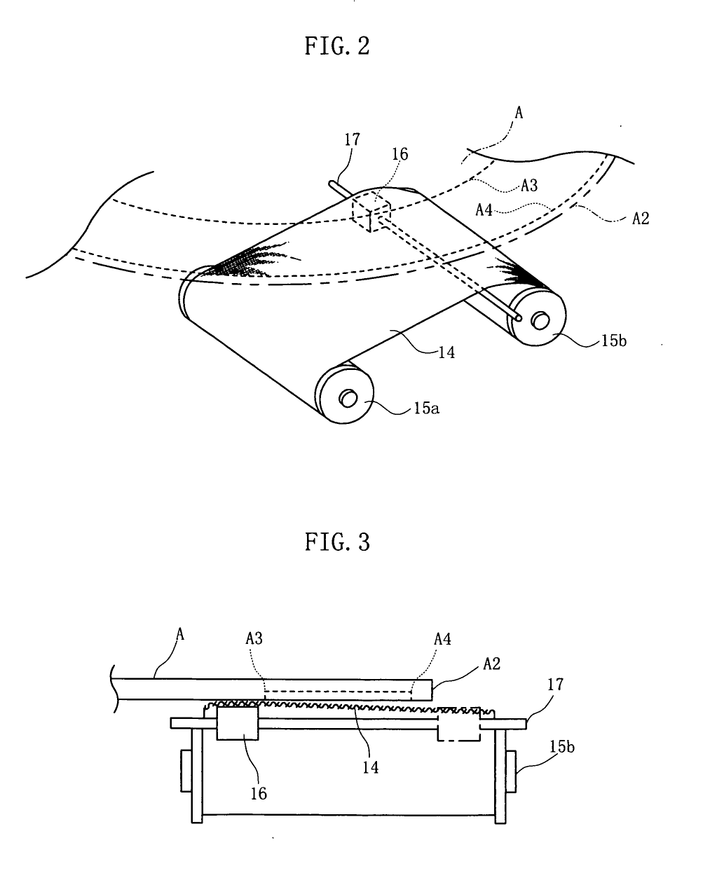

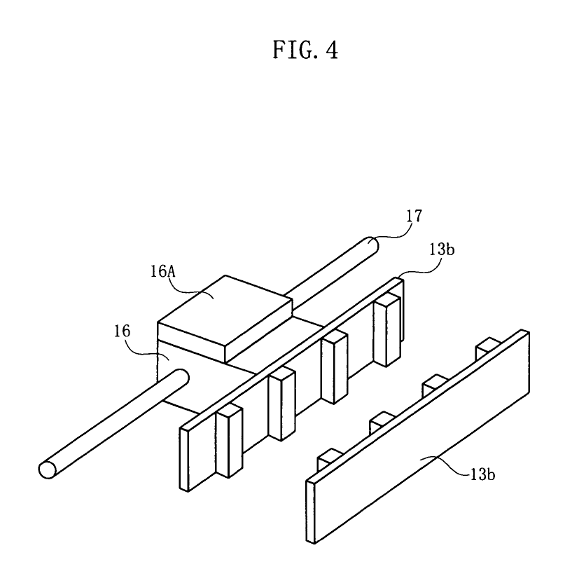

FIG. 1 is a top view that shows the main section of the first Embodiment. FIG. 2 is a perspective view that shows a part of the first Embodiment. FIG. 3 is a side view that shows a part of the first Embodiment. FIG. 4 is a perspective view that shows a part of the first Embodiment.

The disc cleaner relating to the first Embodiment is a cleaner exclusively used for a disc A, such as CD or DVD, and it is equipped with a motor 10, worm gears 11a and 11b, a gear for disc rotation 11c, a belt for disc rotation 11d, a disc spindle 11e, a deceleration gear 11f, a cartridge shell 12, a transmission gear 13a, a movement belt 13b, a cleaning cloth (cleaning member) 14, winding bobbins 15a and 15b, a press member 16 and a guide rod 17, generally. In the disc A, the reading surface is positioned downward over these components, and a hub A1 is set to the cleaner body so as to match-up with the disc spindle 11e. In the disc A, the range from the broken line A3 at the internal circumference side to the broken line A4 at the external circumference side is regarded as a recording region.

The motor 10, the worm gears 11a and 11b, the gear for disc rotation 11c, the belt for disc rotation 11d, disc spindle 11e and the deceleration gear 11f are established at the pre-determined locations inside the cleaner body, respectively. The transmission gear 13a, the movement belt 13b, the cleaning cloth 14, the winding bobbins 15a and 15b, the press member 16 and the guide rod 17 other than the components are established in the cartridge shell 12, which is detachable from the cleaner body. The worm gear 11a, the gear for disc rotation 11c, the belt for disc rotation 11d and the disc spindle 11e comprise a disc rotation mechanism that rotates the disc A. The worm gear 11b, the deceleration gear 11f, the transmission gear 13a, the movement belt 13b and the guide rod 17 comprise a movement mechanism that moves the press member 16 along the radical direction of the disc A. The winding bobbins 15a and 15b comprise a winding mechanism for manually winding the cleaning cloth 14.

When the motor 10 is driven, the disc A rotates via the worm gear 11a, the gear for disc rotation 11c, the belt for disc rotation 11d and the disc spindle 11e. Simultaneously, the press member 16 moves from the internal circumference side to the external circumference side along the radical direction of the disc A via the worm gear 11b, the deceleration gear 11f, the transmission gear 13a, the movement belt 13b and the guide rod 17. As indicated with the chain lines in FIG. 1 and FIG. 3, at the time when the press member 16 reaches a position outside of the external circumference A2 of the disc A, the drive of the motor 10 is stopped, and the disc A and the press member 16 are simultaneously stopped. Furthermore, the press member 16 is at the internal circumference side of the disc A before the start of cleaning. The motor 10 is controlled by a microcomputer equipped with a watch dog timer function that measures the time period from the start of the drive to the time when the press member 16 reaches the pre-determined position, and a limit switch function that directly detects the press member 16, which has reached the pre-determined position. Further, the gear ratio is appropriately determined in order for the press member 16 to move comparatively slowly while the disc A rotates.

The cleaning cloth 14 is made from, for example, a non-woven fabric. Both ends of the cleaning cloth 14 are attached to a pair of the winding bobbins 15a and 15b, respectively, and the cleaning cloth 14 is laid so as to pass between the reading surface of the disc A and the press member 16. A portion of the cleaning cloth 14, extruded toward the disc A side by the press member 16, makes contact with the reading surface, and dust on the reading surface is wiped off by this contact zone. When one of the winding bobbins 15a and 15b is rotated by hand, an unused portion of the cleaning cloth 14 is let out to the contact zone with the reading surface, and the used portion is wound. The winding direction of the cleaning cloth 14 intersects with the movement direction of the press member 16. Further, in the press member 16, as shown in FIG. 4, a pad 16A, formed from an elastic body, such as rubber, is established on a portion where the cleaning cloth 14 is pressed. This pad 16A causes a situation where the cleaning cloth 14 elastically makes contact with the reading surface.

The cleaning procedure is explained next.

Before the start of cleaning, the press member 16 is positioned inside the internal circumference line A3 in the recording region in the state where the cartridge shell 12 is detached from the cleaner body. Further, one of the winding bobbins 15a and 15b is rotated, and an unused portion of the cleaning cloth 14 is let out. Subsequently, the cartridge shell 12 is attached inside the cleaner body, and the transmission gear 13a is engaged with the deceleration gear 11f. In addition, the reading surface is postured downward and the hub A1 is fixed to the disc spindle 11e, and the disc A is set to the cleaner body.

When the cleaning is started, the disc A rotates associated with the drive of the motor 10; simultaneously, the press member 16 starts moving from the internal circumference side to the external circumference side of the disc A. At this time, a portion of the cleaning cloth 14, extruded by the press member 16, makes contact with the reading surface of the disc A, and dust on the reading surface is wiped off by the contact zone of the cleaning cloth 14. Associated with the movement of the press member 16, the contact zone of the cleaning cloth 14 also moves from the internal circumference side to the external circumference side of the disc A. Therefore, on the reading surface, dust is successively wiped off from the internal circumference side to the external circumference side.

When the cleaning is completed, the drive of the motor 10 is stopped in a state where the press member 16 is positioned outside the external circumference A2 of the disc A, and the rotation of the disc A is also stopped in response to stopping the drive of the motor. At this time, the portion of the cleaning cloth 14, extruded by the press member 16, is situated outside of the external circumference line A4 in the recording region of the disc A, and it no longer makes contact with the reading surface Hence, dust will never be accumulated on the recording region of the disc A, and a wiped trace of dust will never remain.

According to the first Embodiment, at the point when the rotation of the disc A is stopped and cleaning is completed, the portion of the cleaning member, extruded by the press member 16 as a dust wiping portion, is no longer situated on the recording region of the disc A, and it is also in a state where it does not contact with the reading surface, so there is no remainder of any wiped trace of dust throughout the reading surface of the disc A including the recording region.

The second Embodiment is explained next. For any aspects similar to the aspects in the above-described Embodiment 1, the explanation shall be omitted.

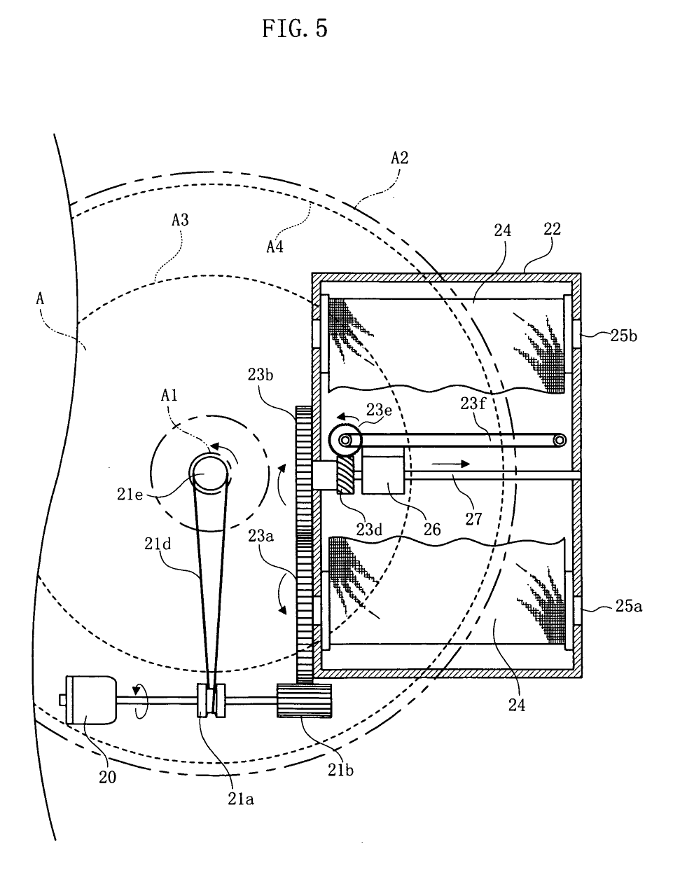

FIG. 5 is a top view that shows the main section of the second Embodiment. The disc cleaner relating to the second Embodiment is also a cleaner exclusively used for the disc A, and is equipped with a motor 20, a pulley 21a, a drive gear 21b, a pulley belt 21d, a disc spindle 21e, a cartridge shell 22, first and second interlock gears 23a and 23b, a worm gear for press movement 23d, a transmission gear for press movement 23e, a movement belt 23f, a cleaning cloth 24, winding bobbins 25a and 25b, a press member 26 and a guide rod 27, generally inside the cleaner body.

The motor 20, the pulley 21a, the drive gear 21b, the pulley belt 21d and the disc spindle 21e are respectively established at pre-determined locations inside the cleaner body. The first and second interlock gears 23a and 23b, the worm gear for press movement 23d, the transmission gear for press movement 23e, the movement belt 23f, the cleaning cloth 24, the winding bobbins 25a and 25b, the press member 26 and the guide rod 27 other than the components are established within the cartridge shell 22. The pulley 21a, the pulley belt 21d and the disc spindle 21e comprise a disc rotation mechanism that rotates the disc A. The drive gear 21b, the first and second interlock gears 23a and 23b, the worm gear for press movement 23d, the transmission gear for press movement 23e, the movement belt 23f and the guide rod 27 comprise a movement mechanism that moves the press member 26 along the radical direction of the disc A. The drive gear 21b, the first interlock gear 23a and the winding bobbing 25a and 25b comprise a winding mechanism for automatically winding the cleaning cloth 24.

When the motor 20 is driven, the disc A rotates via the pulley 21a, the pulley belt 21d and the disc spindle 21e. Simultaneously, the press member 26 moves from the internal circumference side to the external circumference side along the radical direction of disc A via the drive gear 21b, the first and second interlock gears 23a and 23b, the worm gear for press movement 23d, the transmission gear for press movement 23e, the movement belt 23f and the guide rod 27. The aspect where the drive of the motor 20 is stopped at the point when the press member 26 reaches the position outside of the external circumference A2 of the disc A is similar to that of the first Embodiment.

Before the start of cleaning, the drive of the motor 20 causes the rotation of each gear in a direction opposite to the direction indicated by an arrow in the diagram, and results in the automatic setting of the press member 26 at the internal circumference side of the disc A. At this time, the rotation of the first and second interlock gears 23a and 23b and the rotation of the worm gear for press movement 23d, which is concentrically secured with the second interlock gear 23b, result in the movement of the press member 26 toward the left. In the meantime, the first interlock gear 23a and the winding bobbin 25a are connected via a one-way clutch, not shown in the diagram. Consequently, even when the first interlock gear 23a rotates in a direction, opposite from the direction indicated with the arrow in the diagram, the winding bobbin 25a will not rotate but remains stationary. In other words, only when the first interlock gear 23a rotates in the direction indicated by the arrow in the diagram, one winding bobbin 25a rotates in the same direction, and the other winding bobbin 25b naturally rotates by pulling the cleaning cloth 24 out.

The aspect where a portion of the cleaning cloth 24 extruded toward the disc A side by the press member 26, wipes dust off the reading surface, is similar to that in the described Embodiment. However, since one winding bobbin 25a rotates during cleaning, an unused portion is always let out. Consequently, while the contact zone of the cleaning cloth 24 with the reading surface moves from the internal circumference side to the external circumference side of the disc A along with the movement of the press member 26, the contact zone is always a new portion where no dust adheres.

After the cartridge shell 22 is attached to the cleaner body, the press member 26 automatically moves to a position inside of the internal circumference line A3 in the recording region immediately before the start of cleaning.

When cleaning is started, the disc A rotates associated with the drive of the motor 20. Simultaneously, the press member 26 starts moving from the internal circumference side to the external circumference side of the disc A. At this time, since the winding bobbin 25a simultaneously rotates, an unused portion of the cleaning cloth 24 is let out to the contact zone with the reading surface. Consequently, on the reading surface, while the contact zone of the cleaning cloth 24 successively moves from the internal circumference side to the external circumference side, dust is always wiped off by the unused portion where no dust adheres.

The position of the press member 26 upon the completion of cleaning is designed to be a position outside of the external circumference A2 of the disc A, similar to the described Embodiment, enabling no wiped trace of dust to be left on the recording region of the disc A.

According to the second Embodiment, an efficacy similar to that in the first Embodiment can be obtained, as well. Further, since winding of the cleaning cloth 24 during the cleaning causes bringing of a portion of the cleaning cloth 24, which is always new, into contact with the reading surface, the dust wiping efficacy can be more enhanced. Even when detaching the cleaning cloth 24 from the reading surface, the amount of dust adhering onto the contact zone at that moment is small, so dust to be missed can be minimized.

The third Embodiment is explained next. For aspects similar to those in the below-described first and/or second Embodiments, the explanation is omitted.

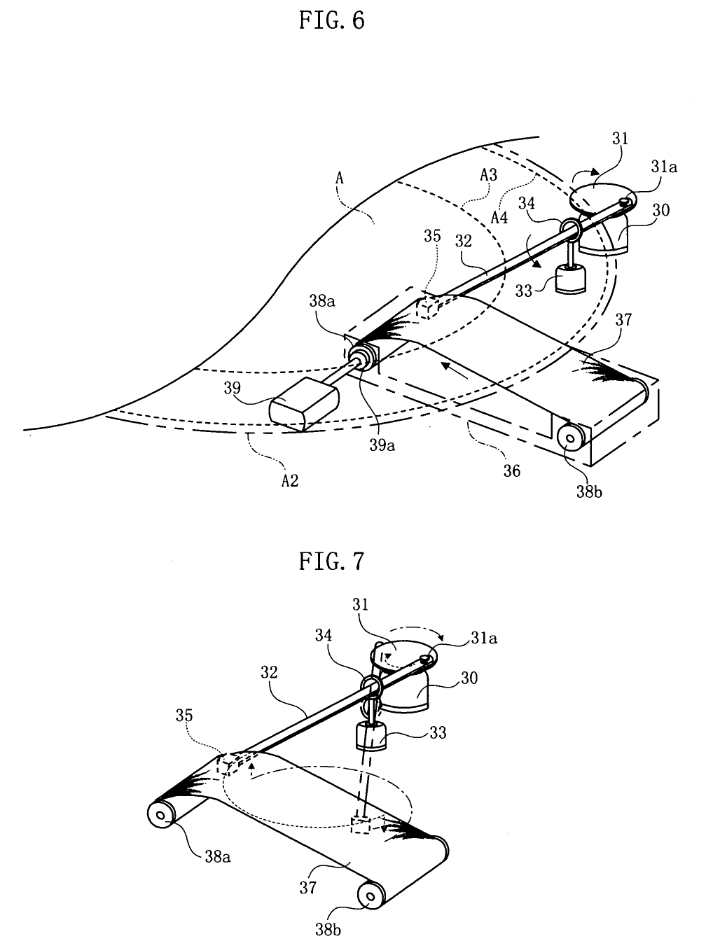

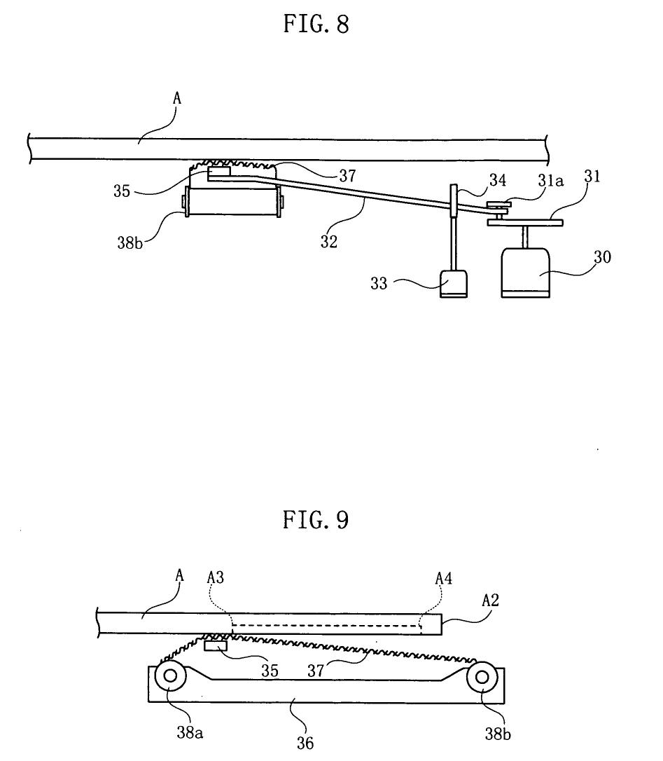

FIG. 6 is a perspective view that shows the main section of the third Embodiment, and FIGS. 7 through 11 are explanatory diagrams for the purpose of explaining the operation according to the third Embodiment, respectively. The disc cleaner relating to the third Embodiment is also a cleaner exclusively used for disc A, and is equipped with a motor for press movement 30, a disc for press movement 31, a connection arm 32, an electromagnetic actuator 33, a support ring 34, a press member 35, a cartridge shell 36, a cleaning cloth 37, winding bobbins 38a and 38b and a motor for winding 39, generally inside the cleaner body.

The motor for press movement 30, the disc for press movement 31, the connection arm 32, the electromagnetic actuator 33, the support ring 34, the press member 35 and the motor for winding 39 are respectively established in pre-determined locations inside the cleaner body. The cleaning cloth 37 and the winding bobbins 38a and 38b other than the components are established within the cartridge shell 36. It will not be especially illustrated, but as a disc rotation mechanism, an exclusive motor generally is built-in inside the cleaner body. The motor for press movement 30, the disc for press movement 31, the connection arm 32, the electromagnetic actuator 33 and the support ring 34 comprise a movement mechanism that moves the press member 35 along the radical direction of the disc A. Winding bobbins 38a and 38b and the motor for winding 39 comprise a winding mechanism for automatically winding the cleaning cloth 37.

The rear anchor of the connection arm 32 is installed to be rotatable in the vicinity of the external circumference of the disc for press movement 31 via a pin 31a. The press member 35 is secured to the end of the connection arm 32. The connection arm 32 is supported by insertion into the support ring 34 so as to be movable to some extent. When the drive of the motor for press movement 30 causes the rotation of the disc for press movement 31, the connection arm 32 oscillates centering on the support ring 34. Therefore, the press member 351 secured to the end portion of the connection arm 32 moves in an arc-like pattern almost along radical direction directly under the cleaning cloth 37. The electromagnetic actuator 33 vertically displaces the support ring 34. Specifically, when the press member 35 moves directly under the cleaning cloth 37, the support ring 34 is pushed to the uppermost part, causing the extrusion of the cleaning cloth 37 toward the reading surface side by the press member 35. In the meantime, when the press member 35 moves within the range not directly under the cleaning cloth 37, since the support ring 34 is pulled down to the lowermost part, it reaches a state where the cleaning cloth 37 does not contact the reading surface. A driving shaft of the motor for winding 39 is connected to the winding bobbin 38a via the connection gear 39a. Since the winding bobbin 38a rotates during cleaning, an unused portion of the cleaning cloth 37 is always let out. The winding direction of the cleaning cloth 37 is opposite from the direction when the press member 35 moves while it makes contact directly under the cleaning cloth 37. Consequently, the same portion of the cleaning cloth 37 will never be in the contact zone.

As the cleaning procedure, immediately before the start of cleaning, as shown in FIG. 6 through FIG. 9, the press member 35 is positioned inside the internal circumference line A3 of the recording region. Further, the positioning of the support ring 34 at the uppermost part causes the extrusion of a portion of the cleaning cloth 37 toward disc A side by the press member 35, and the extruded portion of the cleaning cloth 37 contacts the reading surface of the disc A.

Then, when the disc A rotates and the cleaning is started, the motor for press movement 30 is driven, and accordingly, the press member 35 starts moving from the internal circumference side to the external circumference side of the disc A along an arc locus, indicated by the broken line in FIG. 7. At this time, since the winding bobbin 38a simultaneously rotates, a clean portion of the cleaning cloth 37 will be always let out to the contact zone with the reading surface.

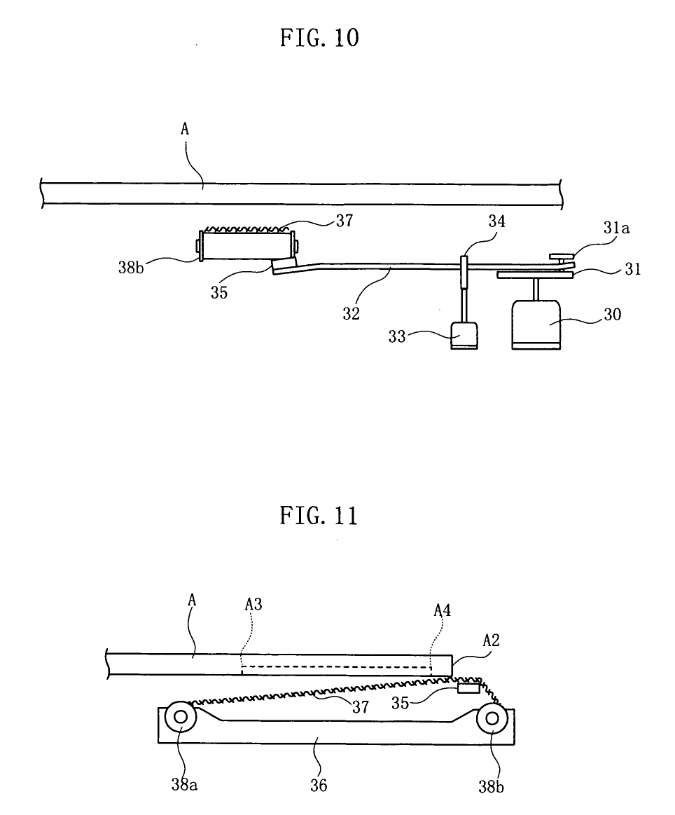

As shown in FIG. 10 and FIG. 11, when the press member 35 reaches the position outside of the external circumference A2 of the disc A, the rotation of the disc A is stopped and the rotation of the winding bobbin 38a is also stopped. Consequently, no wiping trace of dust will remain on the recording region of the disc A.

Then, in preparation for the next cleaning, the motor for press movement 30 is continuously driven. Concurrently, the support ring 34 is positioned at the lowermost part. Consequently, the press member 35 moves along an arc locus, indicated by the dashed line in FIG. 7, and it becomes a state where it is temporarily detached from the cleaning cloth 37. The press member 35 returns to the position where it was immediately prior to the start of cleaning.

According to the third Embodiment, an efficacy of leaving no wiped trace of dust, and another efficacy of more greatly enhancing the wiping efficacy can be obtained.

The fourth Embodiment is explained next. For aspects similar to those in the above-described first through third Embodiments, the explanation is omitted.

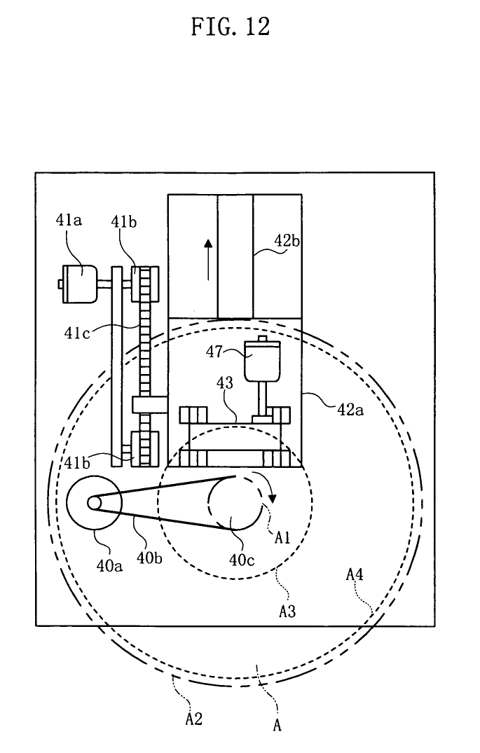

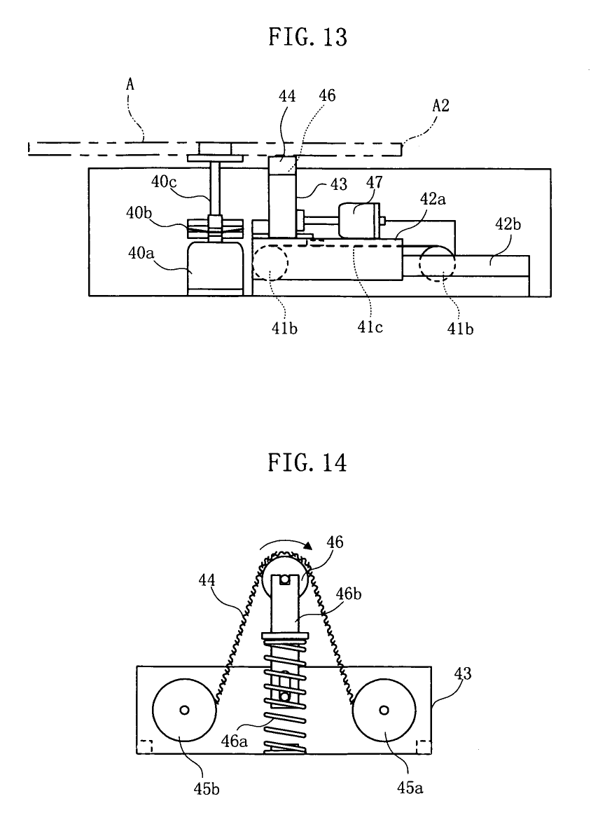

FIG. 12 is a top view that shows the fourth Embodiment, FIG. 13 is a side view of the fourth Embodiment, and FIG. 14 is a side view that shows the main section of the fourth Embodiment. The disc cleaner relating to the fourth Embodiment is also a cleaner that is exclusively used for the disc A, and is equipped with a motor for disc rotation 40a, a belt for disc rotation 40b, a disc rotation shaft 40c, a motor for stage movement 41a, pulleys 41b, a pulley belt 41c, a slide stage 42a, a slide guide 42b, a cleaning cartridge 43, a cleaning cloth 44, winding bobbins 45a and 45b, a press member 46 and a motor for winding 47, generally inside the cleaner body.

The motor for disc rotation 40a, the belt for disc rotation 40b, the disc rotation shaft 40c, the motor for stage movement 41a, the pulleys 41b, the pulley belt 41c, the slide stage 42 and the slide guide 42b are established at the pre-determined locations inside the cleaner body, respectively. The slide stage 42a is connected to the pulley belt 41c; concurrently, it is supported by the slide guide 42b so as to be slidable along the radical direction of the disc A. The cleaning cartridge 43, the cleaning cloth 44, the winding bobbins 45a and 45b, the press member 46 and the motor for winding 47 other than the components are established on the slide stage 42a. Especially, the cleaning cloth 44, the winding bobbins 45a and 45b and the press member 46 are established within the cleaning cartridge 43. The cleaning cartridge 43 is secured at its usual position on the slide stage via a pin and a boss for positioning.

The motor for disc rotation 40a, the belt for disc rotation 40b and the disc rotation shaft 40c comprise a disc rotation mechanism that rotates the disc A. The motor for stage movement 41a, the pulleys 41b, the pulley belt 41c, the slide stage 42a and the slide guide 42b comprise a movement mechanism that moves the press member 46 along the radical direction of the disc A. The winding bobbins 45a and 45b and the motor for winding 47 comprise a winding mechanism for automatically winding the cleaning cloth 44.

When the motor for disc rotation 40a is driven, the disc A rotates via the belt for disc rotation 40b and the disc rotation shaft 40c. When the motor for stage movement 41a is driven, the slide stage 42a horizontally moves along the radical direction of the disc A via the pulleys 41b and 41b, the pulley belt 41c and the slide guide 42b. When the motor for winding 47 is driven, one winding bobbin 45a, housed within the cleaning cartridge 43, rotates, and the cleaning cloth 44 is wound.

As shown in FIG. 14, the press member 46 is comprised of a roller, established so as to elastically extrude the cleaning cloth 44 from the lower side via the spring 46a and the support member 46b. When winding the cleaning cloth 44, the press member 46 rotates while adhering to the cleaning cloth 44. For the cleaning cloth 44, the aspect where any dust on the reading surface is wiped off by the portion extruded toward the disc A side by the press member 46, and the other aspect where one winding bobbin 45a rotates during the cleaning are similar to those in the described Embodiments. Further, the control of each of the motors 40a, 41a and 47 is also similar relative to the aspects where the rotation of the disc A, the movement of press member 46 and the winding of the cleaning cloth 44 are automatically performed, based upon using the procedure similar to the above-described cleaning procedure.

As an aspect that is different from the above-described Embodiments, there is an aspect where the cartridge 43 itself moves from the internal circumference side to the external circumference side of the disc A along with the slide stage 42a. Even in this Embodiment, the aspect where the press member 46 moves from the internal circumference side to the external circumference side of the disc A is not different at all. Further, since the press member 46 elastically presses the cleaning cloth 44 against the reading surface of the disc A, a scratch by comparative large and/or hard dust particles, which are difficult to be wiped off, can be efficiently prevented. As other efficiencies, efficiencies that are similar to those in the above-described Embodiment can be provided.

The fifth Embodiment is explained next. Furthermore, for aspects similar to those in the first through fourth Embodiments, the explanation is omitted.

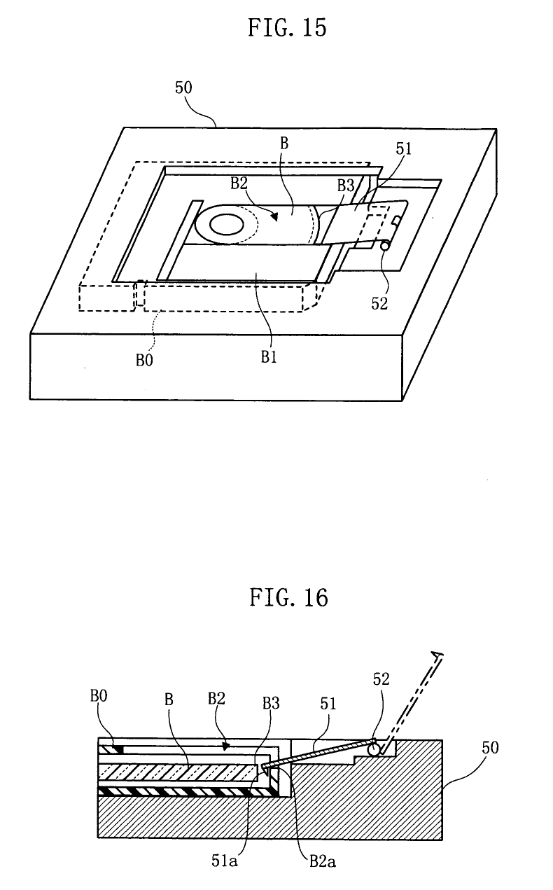

FIG. 15 is a perspective view that shows the fifth Embodiment, and FIG. 16 is a cross sectional view of the fifth Embodiment. The disc cleaner relating to the Embodiment is a cleaner exclusively used for a disc B, such as MD or MO disc, which is housed in a disc cartridge B0. The disc cartridge B0 is set within the cleaner body. After the disc cartridge B0 is set, opening of a shutter B1 in the disc cartridge B0 results in the state where an opening B2 faces outward, and the built-in disc B is cleaned through the opening B2. Cleaning the built-in disc B is not especially illustrated, but cartridge shells 12, 22 and 36, equipped with construction similar to those in the above-described first through third Embodiments, are used. The cartridge shells 12, 22 and 36 are set in a posture turned upside down from those in the first through third Embodiment, in order for the cleaning cloths 14, 24 and 37 to face the opening B2.

Especially as an aspect different from the first through third Embodiment, a thin plate-state member 51, which extends to the outside of the disc cartridge B0 from a gap formed between the outside edge B2a of the opening B2 and the external circumference B3 of the built-in disc B, is established. A spike 51a, which hooks into the outside edge B2a of the opening B2, is established at the end of the plate-state member 51, and its rear anchor is mounted onto a shaft 52 so as to be rotatable via a hinge. After the shutter B1 of the disc cartridge B0 is opened, the plate-state member 51 is set so to hook the spike 51a into the outside edge B2a of the opening B2. After the cartridge shells 12, 22 and 36 are set to the upper portion of the opening B2, cleaning of the built-in disc B is performed based upon the above-described cleaning procedure.

In that case, the press members 16, 26 and 35 are positioned immediately above the plate member 51. At this time, dust which could not be adhered, may fall away from a portion of the cleaning cloths 14, 24 and 37, which have been extruded toward the built-in disc B side (downward) by the press members 16, 26 and 35, respectively. Even though the dust may fall away, the dust is mostly received by the plate-state member 51, so the dust will not remain on the reading surface of the built-in disc B including the recording region and within the disc cartridge B0.

Therefore, according to the fifth Embodiment, it can be utilized as suitable for cleaning the built-in disc B, such as MD or MO, and the efficacies that are similar to those in the above-described Embodiments can be obtained.

The present invention shall not be limited to each of the Embodiments.

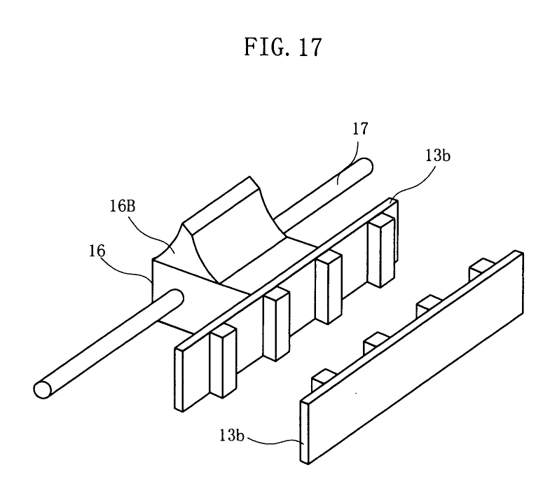

For example, as a modified example of the first Embodiment, as shown in FIG. 17, a pad 16B with a pointed extremity configuration that is pointed to some extent, which is formed from an elastic body, such as rubber, can be established to the press member 16 as a portion to press the cleaning cloth 14. With this pad 16B, the cleaning cloth 14 is elastically pressed against the reading surface of the disc A in a line contact state, so this makes the convolution of comparatively large and hard dust particles generally difficult, and a scratch on the reading surface by the dust can be efficiently prevented. It is needless to say that this pad 16B shall not be limited to the first Embodiment but can be adopted in other Embodiments.

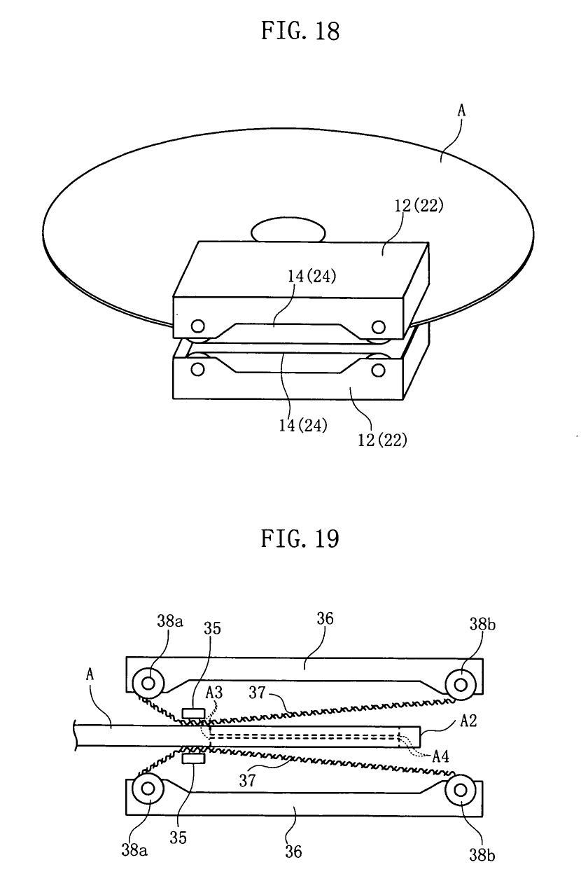

As a modified example of the first and second Embodiments, as shown in FIG. 18, it can be constructed to be equipped with two sets of the cartridge shells 12 and 22 with the same structure; concurrently, to arrange the disc A between these cartridge shells for the purpose of cleaning both sides of the disc A at the same time. Further, as a modified example of the third Embodiment, as shown in FIG. 19, it can have a similar construction. In that case, it is unnecessary to turn over the disc A every time one side has been cleaned, and the double-sided disc A can be promptly cleaned without any trouble.

In each of the Embodiments, it is designed so that the press members 16, 26, 35 and 46 move from the internal circumference side to the external circumference side of the disc A or B. Conversely, these can be designed to move from the external circumference side to the internal circumference side, in which case the press members 16, 26, 35 and 46 move so as to be positioned inside of the internal circumference line A3 in the recording region when cleaning is completed.

Further, when the rotation of the disc A or B is stopped and the cleaning is completed, the press members 16, 26, 35 and 46 do not have to be completely situated outside of the external circumferences A1 or B3 of the disc A or B, respectively, and it is sufficient as long as these are positioned outside the recording region.

1. A disc cleaner comprising a disc cleaner that has a disc rotation mechanism, which rotates a disc, a cleaning member for cleaning a reading surface during the rotation of the disc, and a press member that brings the cleaning member into contact with the reading surface,
wherein the cleaner includes a movement mechanism that moves the press member along the radical direction of the disc during cleaning when the disc rotates, that allows the press member to reach the outside of a recording region of the disc.

2. The disc cleaner according to claim 1, where the movement mechanism moves the press member from the internal circumference side to the external circumference side of the disc.

3. The disc cleaner according to claim 1 or 2, where the movement mechanism allows the press member to reach further outside of the external circumference of the disc when cleaning is completed.

4. The disc cleaner according to claim 1 or 2, where the disc is housed within a disc cartridge, and which has a shutter and an opening; and that additionally has a plate-state member from a gap between the outside edge of the opening which appears in the state with the shutter opened, and the disc, through the outside of the disc cartridge; and where the movement mechanism allows the press member to reach the upper portion of the plate-state member when cleaning is completed.

5. A disc cleaner according to claim 1 or 2, where the cleaning member is a cleaning cloth established so as to pass between the press member and the reading surface, and which additionally has a winding mechanism for winding the cleaning member during cleaning.

6. The disc cleaner according to claim 5, where the winding direction of the cleaning intersects with the movement direction of the press member.

7. The disc cleaner according to claim 5, where the winding direction of the cleaning member is opposite to the movement direction of the press member.

8. The disc cleaner according to claim 1 or 2, where the press member is formed from an elastic body.

9. The disc cleaner according to claim 8, where the press member has a pointed extremity for the purpose of extruding the cleaning member toward the reading surface.

10. The disc cleaner according to claim 1 or 2, where two sets of the cleaning member and press member are established to be cleanable from both sides of the disc.
